(19) United States
(12) Patent Application Publication
(10) Pub. No.: US 2025/0293599 A1
(43) Pub. Date: Sep. 18, 2025

(54) OUTPUT CONTROL CIRCUIT AND SWITCHING REGULATOR INCLUDING THE SAME

(71) Applicant: ABLIC Inc., Nagano (JP)

(72) Inventor: Kosuke TAKADA, Nagano (JP)

(73) Assignee: ABLIC Inc., Nagano (JP)

(21) Appl. No.: 19/060,762

(22) Filed: Feb. 23, 2025

(30) Foreign Application Priority Data
Mar. 12, 2024 (JP) 2024-037730

(51) Int. Cl. H02M 3/156; H02M 1/00; H02M 1/32

(52) U.S. Cl. CPC H02M 3/156; H02M 1/0009; H02M 1/32

(57) ABSTRACT

An output control circuit includes a detection circuit and a control circuit. The detection circuit contains an input port connected to a connection point and an output port which detects a current flowing toward the connection point through an inductor with one end connected to the connection point and outputs a detection signal. The control circuit controls an on or off state of a high-side transistor and a low-side transistor in the case of a signal level of a received signal indicating that an error voltage, which is amplified from a difference between a first reference voltage and a feedback voltage proportional to an output voltage, falls below a second reference voltage, and that the current is detected.

### CROSS-REFERENCE TO RELATED APPLICATION

This application claims the priority benefits of Japanese application no. 2024-037730, filed on Mar. 12, 2024. The entirety of the above-mentioned patent application is hereby incorporated by reference herein and made a part of this specification.

### BACKGROUND

### Technical Field

The present invention relates to an output control circuit and a switching regulator.

### Description of Related Art

Generally, a switching regulator receives a power supply voltage and generates a constant output voltage. It is also desirable for an appropriate protection function to operate even in the case of an abnormal state occurring due to, for example, a ground fault in which the output terminal is shorted to the ground terminal. A conventional switching regulator including an output control circuit includes an overcurrent protection function against a ground fault at the output terminal (refer to Japanese Patent Application Laid-Open No. 2022-146584).

However, the overcurrent protection function included in the conventional switching regulator including an output control circuit is unable to suppress an overcurrent in the case where the output terminal of a synchronous rectification type switching regulator operating in a PWM fixed mode is short-circuited with a node having a voltage higher than a desired voltage such as the power supply voltage (hereinafter referred to as a “high-side node”).

The present invention provides an output control circuit and a switching regulator capable of suppressing an overcurrent even in the case where the output terminal of a synchronous rectification type switching regulator operating in a PWM fixed mode is short-circuited with a high-side node, compared to the conventional one.

### SUMMARY

An output control circuit according to an aspect of the present invention includes: a backflow detection circuit which contains an input port connected to a connection point at which a high-side transistor and a low-side transistor are connected in series, and an output port which detects a backflow current flowing from the other end to one end of an inductor of which one end is connected to the connection point, and outputs a backflow detection signal including a signal level corresponding to a detection result of the backflow current; and a control circuit which controls the on or off state of the high-side transistor and the low-side transistor in response to a signal level of a received signal. The control circuit controls the high-side transistor and the low-side transistor to be off in the case where the signal level of the received signal indicates that an error voltage, which is amplified from a difference between a first reference voltage and a feedback voltage proportional to an output voltage, falls below a second reference voltage, and that the backflow current is detected based on the backflow detection signal.

A switching regulator according to an aspect of the present invention includes: an error amplification circuit which amplifies a difference between a first reference voltage and a feedback voltage proportional to an output voltage, and outputs an error voltage; a comparator which compares the error voltage with a second reference voltage and outputs a detection signal including a signal level corresponding to a comparison result; a high-side transistor and a low-side transistor connected in series; an inductor which includes one end connected to a connection point between the high-side transistor and the low-side transistor and the other end connected to an output terminal; a backflow detection circuit which contains an input port connected to the connection point, and an output port which detects a backflow current flowing from the other end to one end of the inductor, and outputs a backflow detection signal including a signal level corresponding to a detection result of the backflow current; and a control circuit which controls the high-side transistor and the low-side transistor to be off in the case where a signal level of a received signal indicates that the error voltage falls below the second reference voltage based on the detection signal, and that the backflow current is detected based on the backflow detection signal.

According to the output control circuit and the switching regulator, an overcurrent may be suppressed even in the case where the output terminal of a synchronous rectification type switching regulator operating in a PWM fixed mode is short-circuited with a high-side node, compared to the conventional one.

### BRIEF DESCRIPTION OF THE DRAWINGS

FIG. 1 is a circuit diagram illustrating a configuration example of a switching regulator according to an embodiment of the present invention.

FIG. 2 is a schematic diagram illustrating signal waveforms at various nodes of the switching regulator according to the embodiment.

FIG. 3 is a partial circuit diagram illustrating another configuration example of the switching regulator according to the embodiment.

### DESCRIPTION OF THE EMBODIMENTS

An output control circuit and a switching regulator according to an embodiment of the present invention will be described below with reference to the drawings.

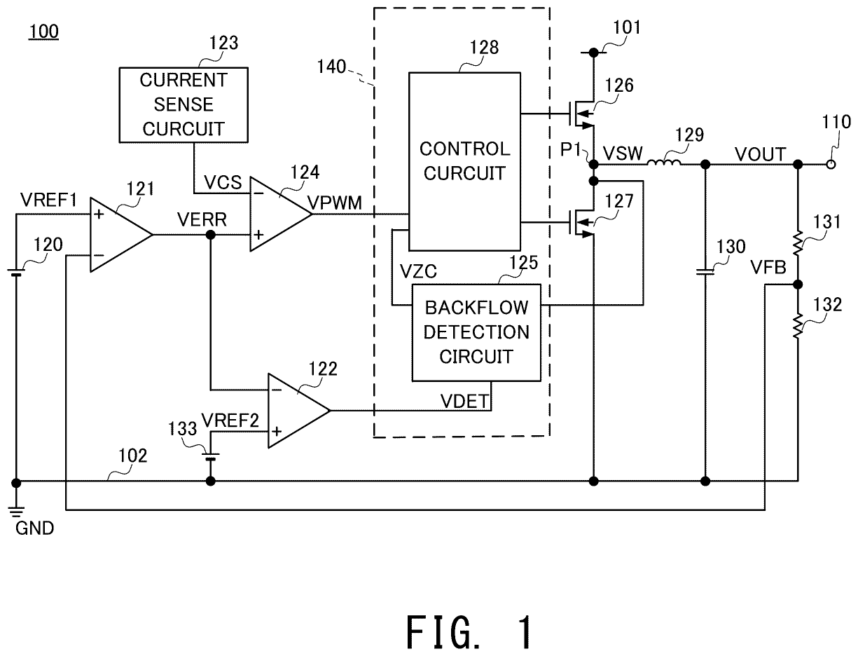

With reference to FIG. 1, a switching regulator 100, which is an example of the switching regulator according to an embodiment of the present invention, will be described.

The switching regulator 100 includes a power supply terminal 101, a ground terminal 102, a first reference voltage source 120, a second reference voltage source 133, an error amplification circuit 121, a comparator 122, a current sense circuit 123, a PWM comparator 124, a backflow detection circuit 125, a control circuit 128, a high-side transistor 126, a low-side transistor 127, an inductor 129, a capacity 130, a resistance 131, a resistance 132, and an output terminal 110. The backflow detection circuit 125 and the control circuit 128 included in the switching regulator 100 constitute an output control circuit 140, which is an example of the output control circuit according to an embodiment of the present invention.

The error amplification circuit 121 has a non-inverted input terminal (+) connected to one end of the first reference voltage source 120, an inverted input terminal (−) connected to the other end of the resistance 131 and one end of the resistance 132, and an output terminal connected to a non-inverted input terminal (+) of the PWM comparator 124 and an inverted input terminal (−) of the comparator 122. The comparator 122 has a non-inverted input terminal (+) connected to one end of the second reference voltage source 133, and an output terminal connected to a first input port of the backflow detection circuit 125.

The PWM comparator 124 has an inverted input terminal (−) connected to an output terminal of the current sense circuit 123, and an output terminal connected to a first input terminal of the control circuit 128. The control circuit 128 has a second input terminal connected to an output port of the backflow detection circuit 125, a first output terminal connected to a gate of the high-side transistor 126, and a second output terminal connected to a gate of the low-side transistor 127. The high-side transistor 126 has a drain connected to the power supply terminal 101, and a source connected to a drain of the low-side transistor 127, a second input port of the backflow detection circuit 125, and one end of the inductor 129. The inductor 129 has the other end connected to one end of the capacity 130, the output terminal 110, and one end of the resistance 131.

The ground terminal 102 is connected to the other end of the first reference voltage source 120, the other end of the second reference voltage source 133, a source of the low-side transistor 127, the other end of the capacity 130, and the other end of the resistance 132.

Next, the basic operation of the output control circuit 140 and the switching regulator 100 is described.

The power supply terminal 101 supplies a predetermined power supply voltage. The ground terminal 102 is a power supply voltage different from a power supply voltage of the power supply terminal 101, and supplies a power supply voltage of 0V (zero volt) (hereinafter referred to as “ground voltage”) as an example of a power supply voltage that serves as a reference for circuit operation.

The inductor 129 and the capacity 130 constitute a smoothing circuit. The smoothing circuit smoothes a pulse voltage generated from a voltage VSW at a connection point P1 at which the high-side transistor 126 and the low-side transistor 127 are connected in series, and outputs a voltage VOUT from the output terminal 110. The resistance 131 and the resistance 132 divide the voltage VOUT of the output terminal 110 and generate a feedback voltage VFB. The error amplification circuit 121 amplifies the difference between a first reference voltage VREF1 output from the first reference voltage source 120 and the feedback voltage VFB, and outputs an error voltage VERR. The current sense circuit 123 converts a drain current of the high-side transistor 126 into a voltage VCS and outputs the voltage VCS. The PWM comparator 124 compares the voltage VCS with the error voltage VERR and outputs a voltage VPWM.

The comparator 122 compares the error voltage VERR with a second reference voltage VREF2 supplied from the second reference voltage source 133, and outputs a voltage VDET including a signal level corresponding to the comparison result. The backflow detection circuit 125 contains an enable/disable switching function, and switches between enabled and disabled according to the level of the voltage VDET received from the first input port. For example, in response to the voltage VDET being at a high level, the backflow detection circuit 125 is enabled, and in response to the voltage VDET being at a low level, the backflow detection circuit 125 is disabled. In addition, the backflow detection circuit 125 monitors the voltage VSW, detects a backflow current flowing from the other end to one end of the inductor 129, and outputs a voltage VZC as a backflow detection signal from the output port.

The backflow detection circuit 125 detects the presence or absence of a backflow current by determining whether the voltage VSW is higher or lower than a predetermined set voltage, for example, 0V. The backflow detection circuit 125 determines that a backflow current is detected in the case of the voltage VSW being higher than 0V, i.e., a positive voltage, while the backflow detection circuit 125 determines that a backflow current is not detected in the case of the voltage VSW being lower than 0V, i.e., a negative voltage. In response to the backflow detection circuit 125 being not detecting a backflow current, the backflow detection circuit 125 outputs the voltage VZC at a first level (for example, low level) corresponding to the detection result of “absence” of a backflow current. On the other hand, in response to the backflow detection circuit 125 being detecting a backflow current, the backflow detection circuit 125 outputs the voltage VZC at a second level (for example, high level) corresponding to the detection result of “presence” of a backflow current.

The control circuit 128 is supplied with the voltage VPWM and the voltage VZC as signals. In the case where the supplied voltage VZC is at a low level, the control circuit 128 alternately turns on and off the high-side transistor 126 and the low-side transistor 127 according to the supplied voltage VPWM. On the other hand, in response to the backflow current in the inductor 129 being detected and the voltage VZC becoming at a high level, the control circuit 128 turns off both the high-side transistor 126 and the low-side transistor 127.

Next, to describe the characteristic configuration of the output control circuit 140 and the switching regulator 100, the circuit operation of the switching regulator 100 is described, including the case where the output terminal 110 is short-circuited with the high-side node.

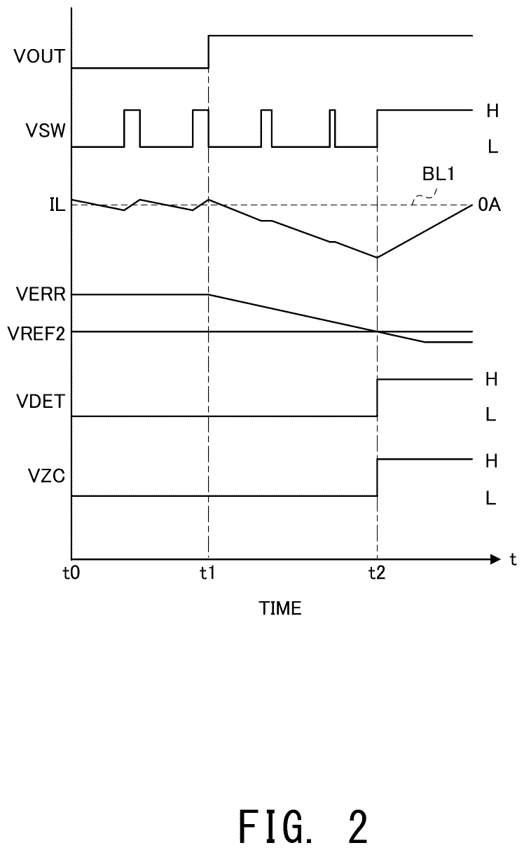

FIG. 2 is a timing chart illustrating waveforms of the voltages VOUT, VSW, VERR, VREF2, VDET, and VZC at major nodes in the switching regulator 100, and a current IL of the inductor 129. Here, the lateral axis represents time t, and the longitudinal axis represents a relative value of a voltage or a current. The voltages VOUT, VSW, VERR, VREF2, VDET, and VZC are the voltages at the output terminal 110, connection point P1, output terminal of the error amplification circuit 121, non-inverted input terminal of the comparator 122, output terminal of the comparator 122, and output port of the backflow detection circuit 125, respectively. The current IL as the inductor current is defined as positive in the direction flowing from one end to the other end of the inductor 129 with 0 A as the reference, and negative in the direction flowing from the other end to one end of the inductor 129.

During the period from time t0 to t1 (t0≤t<t1), the switching regulator 100 illustrates the state of being operating normally in a PWM fixed mode and synchronous rectification. Specifically, the desired voltage is output from the voltage VOUT, and the voltage VSW is a pulse voltage with a constant duty ratio. The current IL increases in the case of the voltage VSW being at a high level (the state at the “H” level in FIG. 2; the same applies hereinafter) and decreases in the case of the voltage VSW being at a low level (the state at the “L” level in FIG. 2; the same applies hereinafter). The state indicates the case of the current output from the output terminal 110 is 0 A (no load), and the average value of the current IL is 0 A (zero ampere). As illustrated in the figure, the current IL has an area where the current IL falls below 0 A and becomes negative, indicating that the current IL is flowing backward. The backflow current is a common current in the operation of a switching regulator in a PWM fixed mode and synchronous rectification.

The second reference voltage VREF2 is set to a voltage value lower than the error voltage VERR in the case of the average current of the current IL being 0 A. In other words, in the normal operating state, since the error voltage VERR is higher than the second reference voltage VREF2, the voltage VDET at the output terminal of the comparator 122 is at a low level. In the output control circuit 140, the backflow detection circuit 125 is in a disabled state, and the voltage VZC is also at a low level. That is, in the normal operating state, operation is performed so that a backflow current is not detected even if a backflow current occurs. In the case where the voltage VZC is at a low level, the output control circuit 140, as described above, allows the high-side transistor 126 and the low-side transistor 127 to be alternately turned on and off according to the voltage VPWM received by the control circuit 128 (normal state).

At time t1 (t=t1), if the node which is 0 the same as the output terminal 110 is short-circuited with a node having a voltage higher than the desired voltage (for example, the power supply voltage), the voltage VOUT rises. In response to the feedback voltage VFB becoming higher than the first reference voltage VREF1, the error voltage VERR decreases. According to the decrease in the error voltage VERR, the duty ratio of the voltage VPWM and the voltage VSW decreases. The current IL experiences an increase in a backflow current due to the rise in the voltage VOUT at the other end of the inductor 129.

At time t2 (t=t2), if the error voltage VERR falls below the second reference voltage VREF2, the voltage VDET becomes at a high level, and the backflow detection circuit 125 is enabled. The backflow detection circuit 125 monitors the voltage VSW, and sets the voltage VZC to a high level in the case of the backflow detection circuit 125 detecting a positive voltage. In the case where the voltage VZC is at a high level, the output control circuit 140 transitions the control circuit 128 from the normal state to the forced off state if the high level voltage VZC is received by the control circuit 128. The control circuit 128 that has transitioned to the forced off state ignores the voltage VPWM and forcibly turns off both the high-side transistor 126 and the low-side transistor 127. After time t2, the backflow of the current IL is suppressed and starts to rise.

According to the output control circuit 140 and the switching regulator 100, by detecting the decrease in the error voltage VERR and enabling the backflow detection circuit 125, and further by turning off both the high-side transistor 126 and the low-side transistor 127 in the case of a backflow current being detected in the inductor 129, an overcurrent can be suppressed even in the case where the output terminal of a synchronous rectification type switching regulator operating in a PWM fixed mode is short-circuited with a high-side node.

The present invention enables suppression of an overcurrent even in the case where the output terminal of a synchronous rectification type switching regulator operating in a PWM fixed mode is short-circuited with a high-side node, compared to the conventional one. In addition, the present invention is not limited to the above-described embodiment, in the implementation stage, implementation may be performed in various forms other than the above-described embodiment, and various omissions, additions, substitutions, or modifications may be made without departing from the spirit of the present invention.

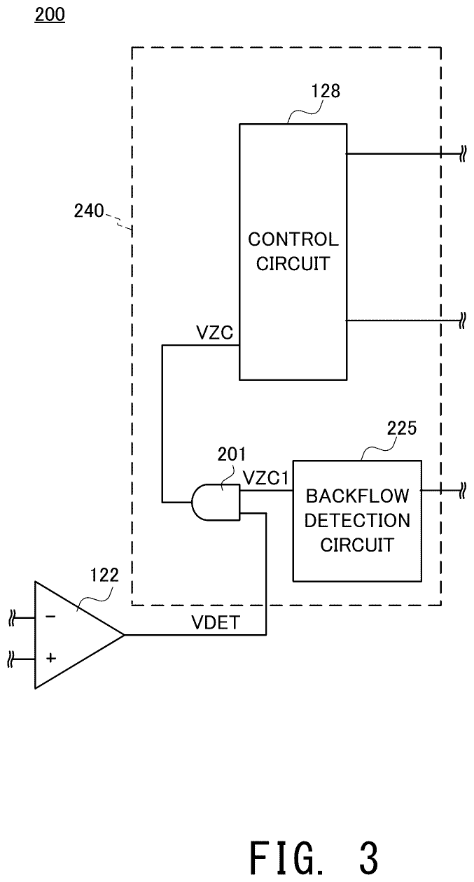

The output control circuit and switching regulator according to the embodiment may have a configuration containing a backflow detection circuit 225 that omits the enable/disable switching function and an AND circuit 201, instead of the backflow detection circuit 125 containing the enable/disable switching function, as exemplified in FIG. 3. In other words, as an example of the output control circuit according to the embodiment, it may be an output control circuit 240 containing the backflow detection circuit 225 and the AND circuit 201. Also, as an example of the switching regulator according to the embodiment, it may be a switching regulator 200 that includes the output control circuit 240.

The AND circuit 201 includes a first input terminal connected to the output terminal of the comparator 122, a second input terminal connected to an output port of the backflow detection circuit 225, and an output terminal that outputs the logical product of signals input received respectively by the first input terminal and the second input terminal. For example, the backflow detection circuit 225 monitors the voltage VSW, and sets a voltage VZC1 to a high level in the case of the backflow detection circuit 225 detecting a positive voltage. The AND circuit 201 outputs the voltage VZC, which is the logical product of the voltage VDET supplied to the first input terminal and the voltage VZC1 supplied to the second input terminal, from the output terminal. Thus, the AND circuit 201 outputs a high level voltage VZC from the output terminal in the case where a high level voltage VDET corresponding to the error voltage VERR falling below the second reference voltage VREF2 and a high level voltage VZC1 corresponding to the detection of a backflow current are supplied, and outputs a low level voltage VZC in other cases.

In the switching regulator according to the embodiment described above, the feedback voltage VFB is a voltage generated by dividing the voltage VOUT, but is not limited thereto. The voltage VOUT may be used as the feedback voltage VFB. In other words, the feedback voltage VFB is a voltage proportional to the voltage VOUT that can be set to k times (where 0<k≤1) the voltage VOUT. Also, the backflow detection circuit 125 described above described the case where 0V is used as an example of a predetermined set voltage (threshold voltage) for detecting the presence or absence of a backflow current, but the predetermined set voltage is not limited to 0V. For example, the predetermined set voltage may be set to a negative voltage near 0V, such as −20 mV. Furthermore, the predetermined set voltage may be set respectively with a voltage difference between the detection side and the detection release side of the backflow current.

Such embodiments and their modifications are included in the scope and spirit of the present invention, and are also included in the present invention described in the claims and their equivalents.

What is claimed is:

1. An output control circuit, comprising:
a detection circuit, containing an input port connected to a connection point at which a high-side transistor and a low-side transistor are connected in series, and an output port which detects a current flowing from the other end to one end of an inductor of which one end is connected to the connection point, and outputs a detection signal comprising a signal level corresponding to a detection result of the current; and
a control circuit, controlling an on or off state of the high-side transistor and the low-side transistor according to a signal level of a received detection signal, and
the control circuit controlling the high-side transistor and the low-side transistor to be off in response to the signal level of the received signal indicating that an error voltage, which is amplified from a difference between a first reference voltage and a feedback voltage proportional to an output voltage, falls below a second reference voltage, and that the current is detected based on the detection signal.

2. The output control circuit according to claim 1, wherein the detection circuit is configured to determine that the current is detected in a case where a voltage at the connection point between the high-side transistor and the low-side transistor is higher than 0V.

3. The output control circuit according to claim 1, wherein the second reference voltage is a predetermined voltage which is lower than the error voltage in response to an average value of an inductor current being 0 A.

4. The output control circuit according to claim 2, wherein the second reference voltage is a predetermined voltage which is lower than the error voltage in response to an average value of an inductor current being 0 A.

5. A switching regulator, comprising:
an error amplification circuit, amplifying a difference between a first reference voltage and a feedback voltage proportional to an output voltage and outputting an error voltage;
a comparator, comparing the error voltage with a second reference voltage and outputting a detection signal comprising a signal level corresponding to a comparison result;
a high-side transistor;
a low-side transistor, connected in series with the high-side transistor;
an inductor, comprising a first end connected to a connection point between the high-side transistor and the low-side transistor, and a second end connected to an output terminal;
a detection circuit, containing an input port connected to the connection point, and an output port which detects a current flowing from the second end to the first end of the inductor, and outputs a detection signal comprising a signal level corresponding to a detection result of the current; and
a control circuit, controlling the high-side transistor and the low-side transistor to be off in response to a signal level of a received signal indicating that the error voltage falls below the second reference voltage based on the detection signal and that the current is detected based on the detection signal.

6. The switching regulator according to claim 5, wherein the detection circuit is configured to determine that the current is detected in a case where a voltage at the connection point between the high-side transistor and the low-side transistor is higher than 0V.

7. The switching regulator according to claim 5, wherein the second reference voltage is a predetermined voltage which is lower than the error voltage in response to an average value of an inductor current being 0 A.

8. The switching regulator according to claim 6, wherein the second reference voltage is a predetermined voltage which is lower than the error voltage in response to an average value of an inductor current being 0 A.
